(19) United States
(12) Patent Application Publication
(10) Pub. No.: US 2004/0193533 A1
(43) Pub. Date: Sep. 30, 2004

(54) Project bidding transaction management system and method

(76) Inventors: Kuo-Chin Chang, Tu-Chen (TW); Wu Ma, Shenzhen (CN); J. Junma Zheng, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/813,410

(22) Filed: Mar. 29, 2004

(30) Foreign Application Priority Data
Mar. 28, 2003 (TW) 92107180

(51) Int. Cl. G06F 17/60

(52) U.S. Cl. 705/37

(57) ABSTRACT

A project bidding transaction management system in accordance with a preferred embodiment of the present invention includes a database server (1) for storing data used or generated in implementing the project bidding transaction management system, and an application server (2) for managing project bidding transactions. The application server includes: a basic data maintenance module (20) for receiving requirements of outsourcing projects, and generating specifications for the outsourcing projects; a bidder selection module (21) for selecting a plurality of suitable bidders from a list of companies wishing to bid on an outsourcing project; a price negotiation management module (22) for performing price negotiations with bidders, and generating price negotiation records; and a bid comparison module (23) for determining a winning bidder as a contractor for each outsourcing project, and generating bid results. A project bidding transaction management method is also disclosed in the present invention.

### BACKGROUND OF THE INVENTION

1. Field of the Invention

The present invention relates to automated project management systems and methods, and especially to a project bidding transaction management system and method which enables an outsourcing company to obtain bids from bidders and contract out a project to a winning bidder via a suitable communication network.

2. Background of the Invention

In a range of industries, companies often have projects that are best outsourced to third-party corporations. Typically, the company prepares specifications for an outsourcing project, and posts or distributes the specifications to interested bidding corporations. The company duly collects competitive pricing bids from those corporations. Typically, a deadline for bid submissions is set, and the bidding process is confidential. Once the deadline passes, the company refuses any more bids and reviews the timely submitted bids. The contract for the project is generally awarded to the lowest bidder, and the winning bidder is notified and announced publicly. The winning bidder proceeds to complete the project according to the specifications, which include a time schedule and costs allotted.

However, the above bidding procedure is generally time-consuming, expensive and administratively burdensome for the company to implement and carry out. The sheer volume of administrative tasks required can be overwhelming. In addition, there is a need for effective safeguards that assure, for example, the quality of products and on-time delivery of the products on the part of the winning bidder. Furthermore, the company needs effective benchmarks pertaining to what a particular project should likely cost, and whether the bidders' bids are realistic in view of the specifications for the outsourcing project and in view of the bidders' own production capabilities.

For the forgoing reasons, there is a need for a fast, efficient project bidding transaction management system and method which enables an outsourcing company to obtain bids from bidders and contract out a project to a winning bidder via suitable communication channels.

### SUMMARY OF THE INVENTION

A main objective of the present invention is to provide a project bidding transaction management system and method, in which an outsourcing company is able to efficiently obtain bids bidders and contract out a project to a winning bidder via suitable communication channels.

To accomplish the above objectives, a project bidding transaction management system in accordance with a preferred embodiment of the present invention is provided. The project bidding transaction management system includes a database server comprising a database for storing data used or generated in implementing the project bidding transaction management system, an application server for managing project bidding transactions, and a plurality of client computers for users to inquire of the data stored in the database.

The application server comprises: a basic data maintenance module for receiving requirements of outsourcing projects, and generating specifications for the outsourcing projects; a bidder selection module for selecting a plurality of suitable bidders from a list of companies wishing to bid on an outsourcing project according to specifications for the outsourcing project, and for downloading basic data on such selected bidders; a price negotiation management module for performing price negotiations with bidders according to quotations offered by the bidders and an acceptable price range from a financial management system, and generating price negotiation records; and a bid comparison module for determining a winning bidder as a contractor for each outsourcing project by comparing the quotations and a base price set for the outsourcing project by the financial management system, and generating bid results.

The project bidding transaction management system is connected with an electronic marketing system and the financial management system through a network. The electronic marketing system provides an operating platform, through which outsourcing organizations can initiate public bidding activities, and collect basic information on bidding companies and their respective quotations. The financial management system is used for setting base prices and acceptable price ranges for outsourcing projects.

Further, the present invention provides a project bidding transaction management method. The method comprises the steps of: generating specifications for an outsourcing project; receiving quotations from bidding companies; selecting a plurality of suitable bidders from a list of the bidding companies according to the quotations and the specifications for the outsourcing project; determining whether it is necessary to negotiate any price with any of the bidders; and determining a contractor for the outsourcing project according to the quotations and the specifications for the outsourcing project.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of an application environment of a project bidding transaction management system in accordance with the preferred embodiment of the present invention;

FIG. 2 is a schematic diagram of software modules of an application server of the system of FIG. 1; and

FIG. 3 is a flowchart of a preferred method for managing project bidding transactions according to the present invention.

### DETAILED DESCRIPTION OF THE INVENTION

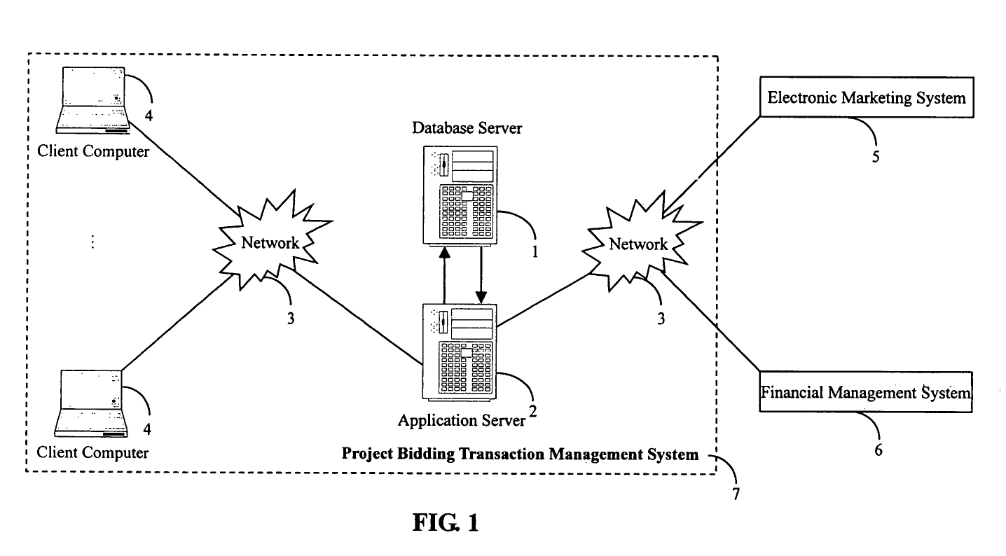

FIG. 1 is a schematic diagram of an application environment of a project bidding transaction management system 7 in accordance with the preferred embodiment of the present invention. The project bidding transaction management system 7 comprises a database server 1, an application server 2, a plurality of client computers 4, and a network 3 interconnecting all the above devices.

The database server 1 comprises a database (not shown) for storing data used or generated in implementing the project bidding transaction management system 7. Such data comprise specifications for outsourcing projects, price negotiation records, and bid results. The application server 2 is provided for generating specifications for outsourcing projects, selecting a plurality of suitable companies as bidders according to the specifications for the outsourcing projects, inquiring of quotations of the bidders, determining whether it is necessary to negotiate a price with any of the bidders, determining winning bidders for the outsourcing projects, and setting project schedules. The client computers 4 are located at different places of an outsourcing organization. Each client computer 4 provides a user interface for users of the organization to inquire of the data stored in the database, and to manage project bidding transactions.

The project bidding transaction management system 7 is connected with an electronic marketing system 5 and a financial management system 6 via the network 3. The electronic marketing system 5 provides an operating platform. Through this platform, various outsourcing organizations can initiate public bidding activities, and collect basic information on bidding companies and their respective quotations. The bidding companies can log on the electronic marketing system 5 through a communications network such as the Internet (not shown). The financial management system 6 is responsible for setting base prices for outsourcing projects, and providing a reasonable price range for each outsourcing project when there is a need to negotiate prices with bidders.

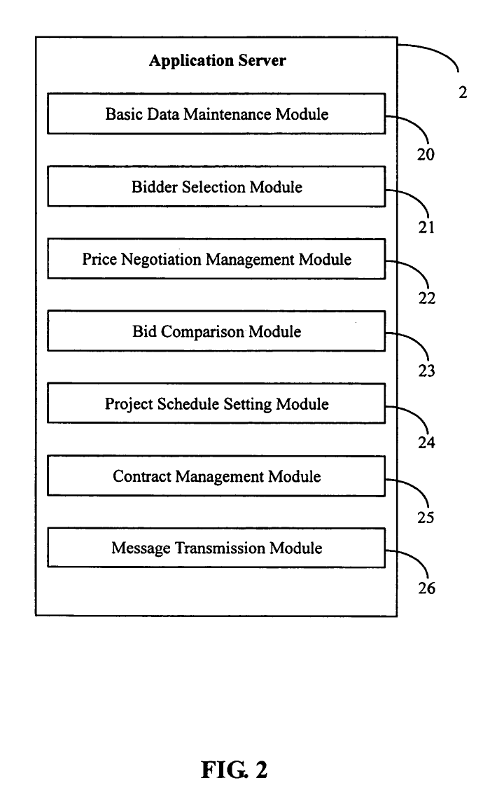

FIG. 2 is a schematic diagram of function modules of the application server 2. The application server 2 comprises a basic data maintenance module 20, a bidder selection module 21, a price negotiation management module 22, a bid comparison module 23, a project schedule setting module 24, a contract management module 25, and a message transmission module 26.

The basic data maintenance module 20 is provided for receiving requirements of outsourcing projects from the client computers 4, and generating specifications for the outsourcing projects. The bidder selection module 21 is provided for selecting a plurality of suitable bidders from a list of companies wishing to bid on an outsourcing project according to specifications for the outsourcing project, and for downloading basic data on such selected bidders. The price negotiation management module 22 is operable for performing price negotiations with bidders according to quotations offered by the bidders and an acceptable price range set by the financial management system 6, and generates price negotiation records. The bid comparison module 23 is used for determining a winning bidder as a contractor for each outsourcing project by comparing the quotations and a base price set for the outsourcing project by the financial management system 6, and generating bid results. The project schedule setting module 24 is used for compiling project schedules according to specifications for the outsourcing projects and implementation plans provided by winning bidders. The contract management module 25 provides different legal contract templates for the outsourcing organization and the contractors, and manages contracts signed between the respective parties. The message transmission module 26 is provided for generating notices recording the bid results, and transmitting the notices to corresponding contractors.

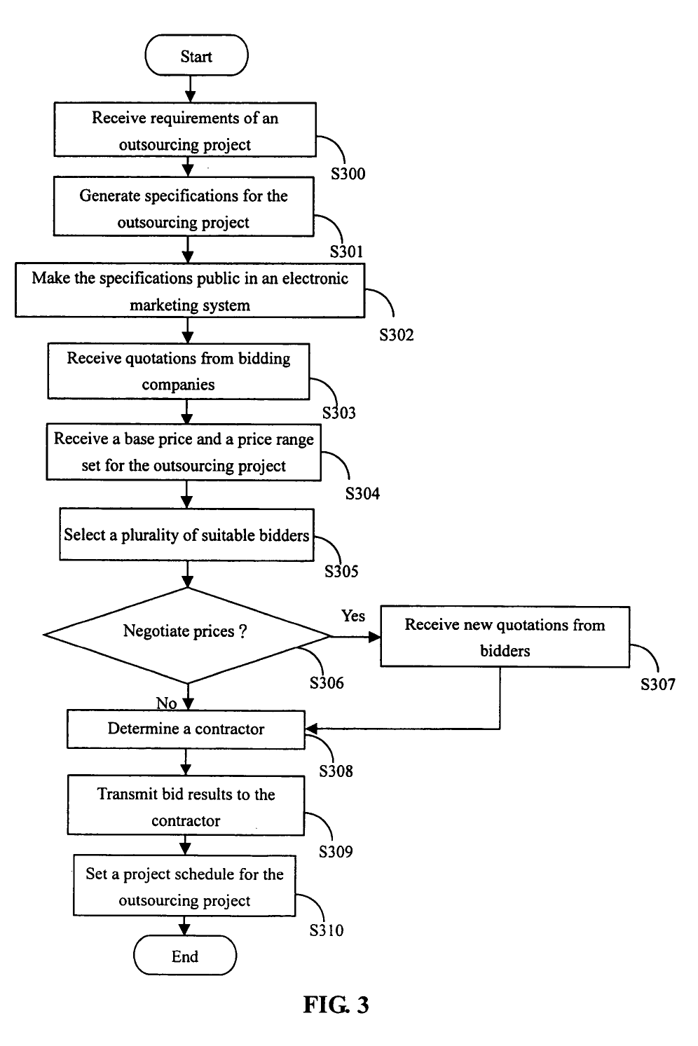

FIG. 3 is a flowchart of a preferred method for managing bidding transactions for an outsourcing project according to the present invention. In step S300, users of an outsourcing organization input requirements of the outsourcing project through any one of the client computers 4. The requirements of the outsourcing project are received by the application server 2 via the network 3, and arranged by the basic data maintenance module 20. In step S301, the basic data maintenance module 20 generates specifications for the outsourcing project according to the requirements. In step S302, the specifications for the outsourcing project are transmitted to the electronic marketing system 5 through the network 3, and are made public by the electronic marketing system 5. In step S303, companies wishing to bid on the outsourcing project offer their respective quotations by logging on the electronic marketing system 5. The electronic marketing system 5 collects basic data on those bidding companies and their respective quotations, and generates a list of the bidding companies that records all the above information. In step S304, the list of the bidding companies is transmitted to the project bidding transaction management system 7 through the network 3. Meanwhile, the application server 2 receives a base price and an acceptable price range set for the outsourcing project from the financial management system 6 via the network 3. In step S305, the bidder selection module 21 selects a plurality of suitable bidders according to information specified in the list of the bidding companies and the base price. In step S306, the price negotiation management module 22 determines whether it is necessary to negotiate a price with any of the selected bidders according to the quotations and the acceptable price range.

If it is not necessary to negotiate prices with the selected bidders, the procedure goes directly to step S308 described below. If it is necessary to negotiate any price with any of the bidders, in step S307, the price negotiation management module 22 receives a new quotation offered by each such bidder from the electronic marketing system 5. A corresponding price negotiation record is then generated, and stored in the database server 1. In step S308, the bid comparison module 23 evaluates all the quotations as well as the basic data on the bidding companies according to the specifications for the outsourcing project, and determines a winning bidder as a contractor for the outsourcing project. In step S309, bid results are arranged by the bid comparison module 23, and transmitted to the electronic marketing system 5. The electronic marketing system 5 issues the bid results, and declares an end to the project bidding transactions. Meanwhile, a notice recording the bid results is generated in the application server 2, and transmitted to the contractor by the message transmission module 26. In step S310, the contractor provides an implementation plan for the project. The outsourcing organization sets a project schedule through the project schedule setting module 24 according to the implementation plan and the specifications for the outsourcing project. 21 In general, the project bidding transaction management system and method of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention, which is defined by the claims appended hereto and allowable equivalents thereof.

What is claimed is:

1. A project bidding transaction management system connectable with an electronic marketing system and a financial management system, the project bidding transaction management system comprising:
a database server comprising a database for storing data used or generated in implementing the project bidding transaction management system; and
an application server for managing project bidding transactions, the application server comprising:
a basic data maintenance module provided for receiving requirements of outsourcing projects, and generating specifications for the outsourcing projects according to the requirements;
a bidder selection module provided for selecting a plurality of suitable bidders from a list of companies wishing to bid on an outsourcing project according to the specifications for the outsourcing project, and for downloading basic data on such selected bidders;
a price negotiation management module provided for performing price negotiations with bidders according to quotations offered by the bidders and an acceptable price range set by the financial management system, and generating price negotiation records; and
a bid comparison module provided for determining a contractor for each of the outsourcing projects by comparing the quotations and a base price set for the outsourcing project by the financial management system, and generating bid results.

2. The project bidding transaction management system according to claim 1, further comprising a plurality of client computers, each of the client computers providing a user interface for users of an outsourcing organization to inquire of the data stored in the database.

3. The project bidding transaction management system according to claim 1, wherein the application server further comprises a project schedule setting module provided for compiling project schedules according to specifications for the outsourcing projects and implementation plans provided by the contractors.

4. The project bidding transaction management system according to claim 1, wherein the application server further comprises a contract management module for providing different legal contract templates for the outsourcing organization and respective contractors, and managing contracts signed between respective parties.

5. The project bidding transaction management system according to claim 1, wherein the application server further comprises a message transmission module provided for generating notices recording the bid results, and transmitting the notices to corresponding contractors.

6. The project bidding transaction management system according to claim 1, wherein the electronic marketing system provides an operating platform through which outsourcing organizations can initiate public bidding activities, and collect basic information on bidding companies and their respective quotations.

7. The project bidding transaction management system according to claim 1, wherein the financial management system is provided for setting base prices and acceptable price ranges for outsourcing projects.

8. A computer-enabled project bidding transaction management method, comprising the steps of:
generating specifications for an outsourcing project;
receiving quotations from bidding companies;
selecting a plurality of suitable bidders from a list of the bidding companies according to the quotations and the specifications for the outsourcing project;
determining whether it is necessary to negotiate any price with any of the bidders; and
determining a contractor for the outsourcing project according to the quotations and the specifications for the outsourcing project.

9. The method according to claim 8, further comprising the step of receiving requirements of the outsourcing project from any one or more client computers.

10. The method according to claim 8, further comprising the step of making the specifications for the outsourcing project public in an electronic marketing system.

11. The method according to claim 8, further comprising the step of setting a project schedule according to an implementation plan provided by the contractor and the specifications for the outsourcing project.

12. A method of making a computer-enabled project bidding transaction management comprising steps of:
providing an application server for managing project bidding transactions including:
providing a basic data maintenance module provided for receiving requirements of outsourcing projects, and generating specifications for the outsourcing projects according to the requirements;
providing a bidder selection module provided for selecting a plurality of suitable bidders from a list of companies wishing to bid on an outsourcing project according to the specifications for the outsourcing project, and for downloading basic data on such selected bidders;
providing a price negotiation management module provided for performing price negotiations with bidders according to quotations offered by the bidders and an acceptable price range set by a financial management system, and generating price negotiation records; and
a bid comparison module provided for determining a contractor for each of the outsourcing projects by comparing the quotations and a base price set for the outsourcing project by the financial management system, and generating bid results.
